(19) United States
(12) Patent Application Publication
(10) Pub. No.: US 2026/0031573 A1
(43) Pub. Date: Jan. 29, 2026

(54) ANTI-DROPOUT STRUCTURE FOR PLUGS, AND PLUG

(71) Applicant: JOININ GLOBAL PTE.LTD., SG (SG)

(72) Inventor: Hongbing ZHENG, Hangzhou (CN)

(73) Assignee: JOININ GLOBAL PTE.LTD., SG (SG)

(21) Appl. No.: 18/783,550

(22) Filed: Jul. 25, 2024

(51) Int. Cl. H01R 13/639; H01R 13/518

(52) U.S. Cl. CPC H01R 13/639; H01R 13/518

(57) ABSTRACT

An anti-dropout structure for plugs and a plug are provided. The anti-dropout structure comprises a ring sleeve having an axial through hole, and the through hole of the ring sleeve is configured for accommodating a male plug and a female plug. The ring sleeve is provided with a circumferential gap including an opening and closing structure. The male plug and female plug are configured to enter the through hole through the circumferential gap, and the ring sleeve further comprises anti-dropout walls protruding toward the through hole for preventing the male plug from being disconnected with the female plug. The anti-dropout walls comprise first position-limiting structures, and each of the male plug and female plug is provided with second position-limiting structures. The first position-limiting structures are configured to abut the second position-limiting structures to prevent the male plug from being disconnected with the female plug.

### FIELD OF THE INVENTION

The present disclosure relates to the field of connectors, and in particular, to an anti-dropout structure for plugs and a plug.

### BACKGROUND OF THE INVENTION

After connecting male and female plugs, they may tend to come loose due to external forces. When the plug is partially detached, there's also a risk of short circuits and fires.

FIG. 1 illustrates LED light strings commonly used in outdoor spaces such as courtyards, corridors, and fences. Each LED light string has male and female plugs at both ends. When multiple light strings need to be connected, adjacent strings are joined using these plugs. However, once the light strings are hung up, their weight or external forces can cause the male and female plugs to loosen, resulting in partial or complete detachment. Additionally, since light strings are often hung at elevated positions, reconnecting the loose plugs can be challenging, leading to a poor user experience.

Based on this, an anti-dropout structure for plugs is proposed.

### SUMMARY OF THE INVENTION

A first aspect of the present disclosure provides an anti-dropout structure for plugs, which addresses safety concerns arising from the loosening of male and female plug connections, improves product safety, and enhances user experience.

In order to achieve above objects, the present disclosure adopts the following technical solutions.

The anti-dropout structure comprises a ring sleeve, the ring sleeve has an axial through hole, and the through hole of the ring sleeve is configured for accommodating a male plug and a female plug. The ring sleeve is provided with a circumferential gap including an opening and closing structure. The male plug and the female plug are configured to enter the through hole through the circumferential gap, and the ring sleeve further comprises anti-dropout walls protruding toward the through hole for preventing the male plug and the female plug from axially dropping out of the anti-dropout structure. The anti-dropout walls comprise first position-limiting structures. Each of the male plug and female plug is provided with second position-limiting structures. The first position-limiting structures are configured to abut the second position-limiting structures to prevent the male plug and the female plug from dropping out of the anti-dropout structure.

In one embodiment, the opening and closing structure comprises a mounting buckle and an active leaf. The ring sleeve comprises a first edge and a second edge, and the first edge is spaced apart from the second edge to form the gap. One side of the active leaf is connected to the first edge, and the active leaf is rotatable around the first edge. The mounting buckle is disposed on the second edge, and the active leaf is provided with a mounting hole snap-fittedly connected to the mounting buckle.

In one embodiment, the anti-dropout structure comprises one or more extension lines and one or more collars. A first end of each extension line is connected to the ring sleeve, a second end of each extension line is connected to one of the collars, and the collars are configured to be sleeved around cables of the plugs.

In one embodiment, the extension lines comprise a first extension line and a second extension line, and the collars comprise a first collar and a second collar. A first end of the first extension line is connected to the ring sleeve, a second end of the first extension line is connected to the first collar, and the first collar is configured to sleeve around the cable of one of the male plug and the female plug. A first end of the second extension line is connected to the ring sleeve, a second end of the second extension line is connected to the second collar, and the second collar is configured to sleeve around the cable of the other one of the male plug and the female plug.

In one embodiment, the ring sleeve is formed by one-piece molding using soft materials.

In one embodiment, each of the second position-limiting structures of the male plug is disposed at a side surface of the male plug and the second position-limiting structures of the male plug comprise protrusions from two side surfaces of the male plug. The second position-limiting structures of the male plug are configured to abut the first position-limiting structures, to prevent the male plug from being disconnected with the female plug.

In one embodiment, each of the second position-limiting structures of the female plug is disposed at a side surface of the female plug and the second position-limiting structures of the female plug comprise protrusions from two side surfaces of the female plug. The second position-limiting structures of the female plug are configured to abut the first position-limiting structures, to prevent the female plug from being disconnected with the male plug.

In one embodiment, each of the second position-limiting structures of the male plug is disposed at a side surface of the male plug and the second position-limiting structures of the male plug comprise protrusions from three side surfaces of the male plug. The second position-limiting structures of the male plug are configured to abut the first position-limiting structures, to prevent the male plug from being disconnected with the female plug.

In one embodiment, each of the second position-limiting structures of the female plug is disposed at a side surface of the female plug and the second position-limiting structures of the female plug comprise protrusions from three side surfaces of the female plug. The second position-limiting structures of the female plug are configured to abut the first position-limiting structures, to prevent the female plug from being disconnected with the male plug.

In one embodiment, each of the second position-limiting structures of the male plug is disposed at a side surface of the male plug and the second position-limiting structures of the male plug comprise protrusions from all side surfaces of the male plug. The second position-limiting structures of the male plug are configured to abut the first position-limiting structures, to prevent the male plug from being disconnected with the female plug.

In one embodiment, each of the second position-limiting structures of the female plug is disposed at a side surface of the female plug and the second position-limiting structures of the female plug comprise protrusions from all side surfaces of the female plug. The second position-limiting structures of the female plug are configured to abut the first position-limiting structures, to prevent the female plug from being disconnected with the male plug.

In one embodiment, the second position-limiting structures of the male plug are disposed at a top portion, a middle portion, and/or a bottom portion of the male plug. The second position-limiting structures of the female plug are disposed at a top portion, a middle portion and/or a bottom portion of the female plug.

In one embodiment, each of the second position-limiting structures of the male plug extends outward from a corresponding side surface of the male plug at an angle with said side surface. Each of the second position-limiting structures of the female plug extends outward from a corresponding side surface of the female plug at an angle with said side surface.

In one embodiment, each of the second position-limiting structures of the male plug and the female plug matches one of the first position-limiting structures. The anti-dropout structure comprises at least two first position-limiting structures.

In one embodiment, the male plug and the second position-limiting structures disposed thereon are formed by one-piece molding of PVC plastic materials, and the female plug and the second position-limiting structures disposed thereon are formed by one-piece molding of PVC plastic materials.

A second aspect of the present disclosure provides a plug comprising an anti-dropout structure according to any one of embodiments in the first aspect of the present disclosure.

The anti-dropout structure and the plug of the present disclosure have the following advantages.

By incorporating the anti-dropout structure at the cables of the male and female plugs, it effectively addresses the issue of plug detachment due to pulling forces, enhancing product safety and user experience. Additionally, the anti-dropout structure can be easily applied to traditional plugs, making it widely applicable.

The anti-dropout structure features a straightforward design and can be achieved through one-piece molding, reducing production costs and improving efficiency.

The anti-dropout structure is designed to integrate the cables of the male and female plugs through the collars and extension lines, making installation easier for users, particularly when working at elevated heights.

The second position-limiting structures of the male and female plugs are configured to abut the first position-limiting structures on the anti-dropout structure, effectively preventing axial displacement and ensuring reliable connections.

### BRIEF DESCRIPTION OF DRAWINGS

FIG. 1 shows a schematic diagram illustrating a connection between a male plug and a female plug of light strings in the prior art.

FIG. 2 shows a schematic diagram illustrating a connection between a male plug and a female plug of light strings featuring an anti-dropout structure of the present disclosure.

FIG. 3 shows a schematic perspective view of the anti-dropout structure of the present disclosure.

FIG. 4 shows a schematic perspective view of the anti-dropout structure of the present disclosure, viewing from another angle.

FIG. 5 shows a sectional view of the anti-dropout structure in FIG. 4.

FIG. 6 shows a side view of the anti-dropout structure in FIG. 4.

FIG. 7 shows a sectional view of one embodiment of the circled region in FIG. 2.

FIG. 8 shows a sectional view of another embodiment of the circled region in FIG. 2.

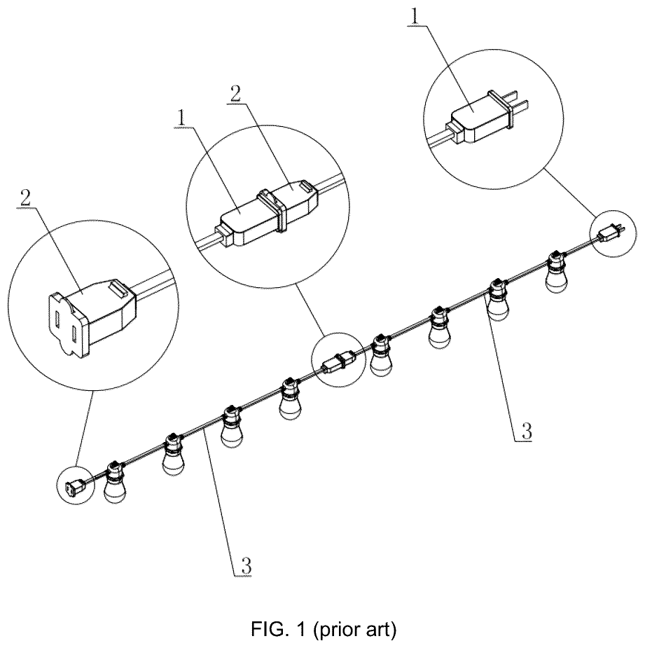

### REFERENCE NUMERALS

1 Male plug
2 Female plug
3 Light string
301 Cable
4 Anti-dropout structure
401 Ring sleeve
402 Circumferential gap
4021 First edge
4022 Second edge
403 Anti-dropout wall
404 Mounting buckle
405 Active leaf
406 Mounting hole
407 Extension line
408 Collar
5 Second position-limiting structure

### DETAILED DESCRIPTION OF THE INVENTION

The present disclosure is described in further detail below in conjunction with exemplary embodiments. It should be noted that terms such as “up”, “down”, “front”, “back”, “left”, “right”, “top”, “bottom”, “inside”, and “outside” indicate the orientation or position relationship based on those shown in the accompanying drawings. It is only for the convenience of describing and simplifying the description, and does not indicate or imply that the device or component mentioned must have a specific orientation, be constructed and operated in a specific orientation, and cannot be construed as restricting the present disclosure.

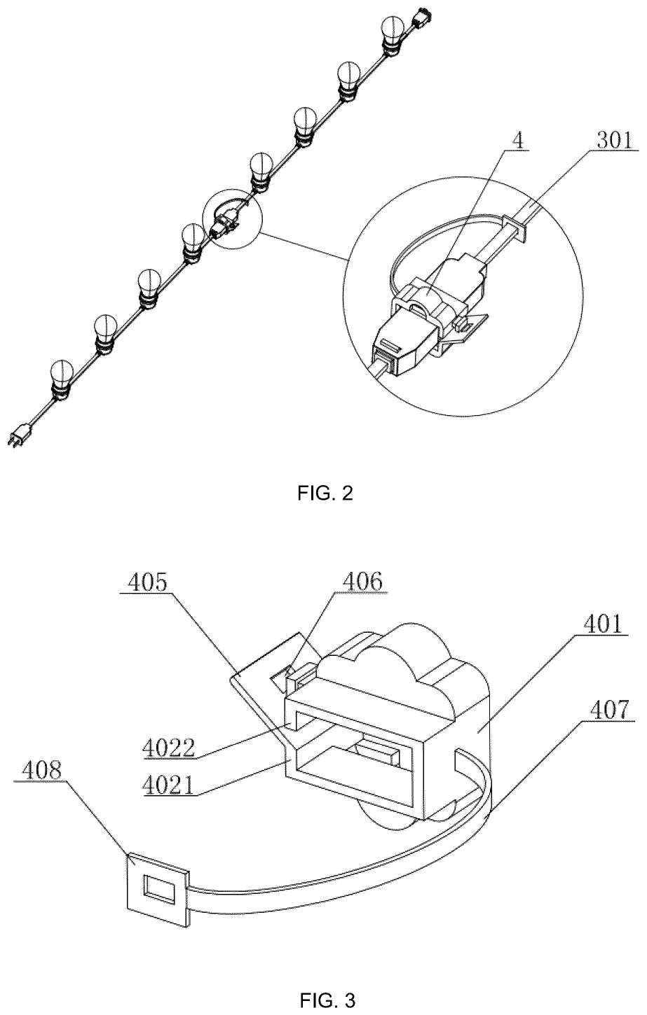

In the context of light string's application, the present disclosure outlines an anti-dropout structure 4 for plugs. As shown in FIG. 2, two light strings 3 are connected to each other through a male plug and a female plug configured with the anti-dropout structure 4.

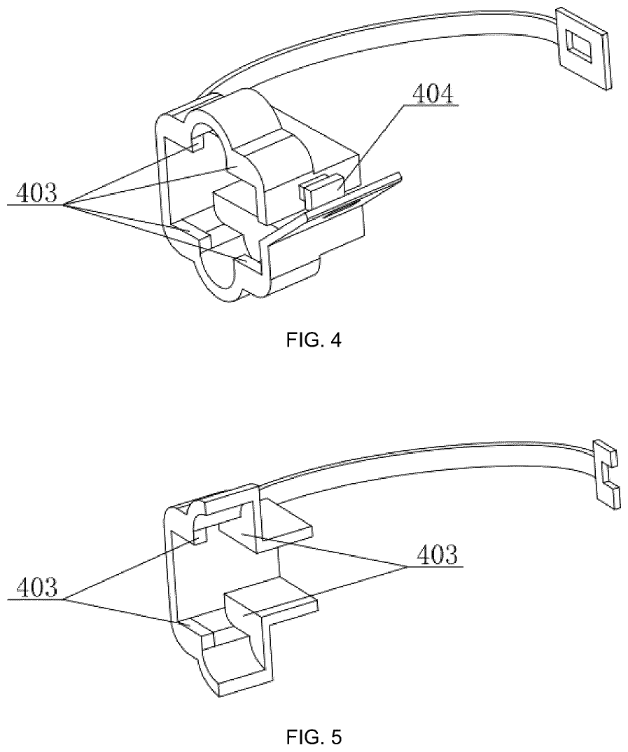

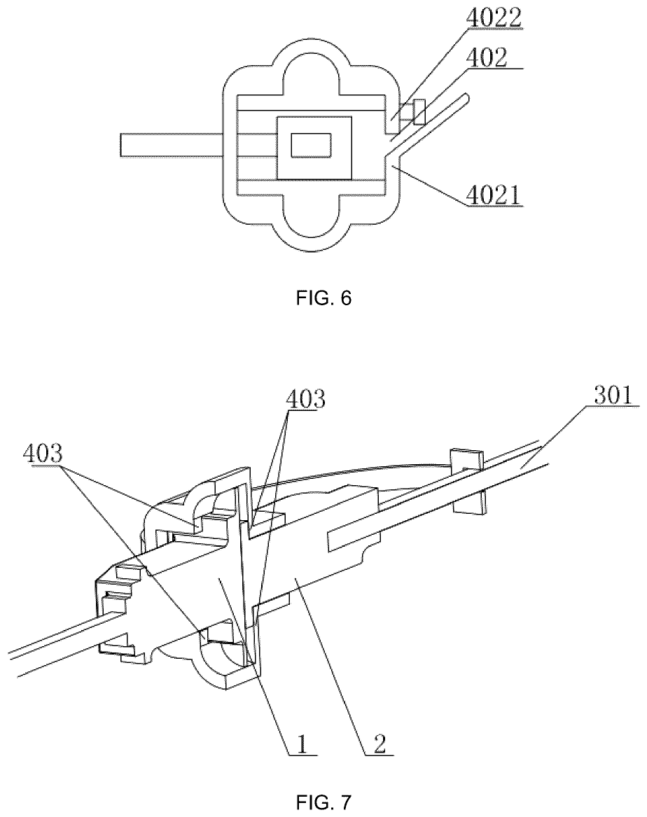

Referring to FIG. 3 to FIG. 6, the anti-dropout structure 4 comprises a ring sleeve 401, the ring sleeve 401 has an axial through hole, and the through hole of the ring sleeve 401 is configured for accommodating a male plug 1 and a female plug 2. The ring sleeve 401 is provided with a circumferential gap 402 including an opening and closing structure. The male plug 1 and the female plug 2 are configured to enter the through hole through the circumferential gap 402, and the ring sleeve 401 further comprises anti-dropout walls 403 protruding toward the through hole for preventing the male plug 1 and the female plug 2 from axially dropping out of the anti-dropout structure 4; that is, the anti-dropout walls are configured to clamp the male plug and the female plug together. The opening and closing structure comprises a mounting buckle 404 and an active leaf 405. The ring sleeve 401 comprises a first edge 4021 and a second edge 4022, and the first edge 4021 is spaced apart from the second edge 4022 to form the circumferential gap 402. One side of the active leaf 405 is connected to the first edge 4021, and the active leaf 405 is rotatable around the first edge 4021. The mounting buckle 404 is disposed on the second edge 4022, and the active leaf 405 is provided with a mounting hole 406, which can be snap-fittedly connected to the mounting buckle 404.

When using the anti-dropout structure 4, the active leaf 405 rotates away from the second edge 4022, opening the circumferential gap 402. The male plug 1 and the female plug 2 are first connected to each other and then enter the through hole through the circumferential gap 402. As shown in FIG. 7, the anti-dropout walls 403 clamp the connected male and female plugs together, effectively preventing disconnection due to axial displacement. After the connected male and female plugs are correctly positioned within the through hole, the active leaf 405 rotates back to the second edge 4022, and the mounting hole 406 of the active leaf 405 snap-fits onto the mounting buckle 404; at which time, the circumferential gap 402 is closed, and the anti-dropout structure 4 secures the connected male and female plugs. To simplify installation, the anti-dropout structure 4 comprises one or more collars 408 and one or more extension lines 407, and the collars 408 are configured to be sleeved around cables 301 of the plugs, such that the anti-dropout structure 4 and the cables 301 form an integrated structure, making installation easier for users, particularly when working at elevated heights.

In another embodiment of the present disclosure, the extension lines comprise a first extension line and a second extension line, and the collars comprise a first collar and a second collar. A first end of the first extension line is connected to the ring sleeve, a second end of the first extension line is connected to the first collar, and the first collar is configured to sleeve around the cable of the male plug. A first end of the second extension line is connected to the ring sleeve, a second end of the second extension line is connected to the second collar, and the second collar is configured to sleeve around the cable of the female plug.

It should be noted that the numbers and shapes of the extension lines and the collars can be adjusted based on actual needs. The ring sleeve 401 is formed by one-piece molding using soft materials, so that the circumferential gap 402 does not need to be excessively large to allow the plugs to pass through. When using the anti-dropout structure 4, users simply use their hands to widen the circumferential gap 402, allowing the male and female plugs to fit into the through hole. The soft material's flexibility ensures that the ring sleeve 401 securely wraps around the male and female plugs, preventing any accidental disconnection. Additionally, the use of soft materials allows for seamless integration of the active leaf 405 and the first edge 4021 through one-piece molding, eliminating the need for separate rotating components such as axles or hinges. Commonly used thermoplastic elastomers, such as thermoplastic elastomer (TPE), thermoplastic vulcanizate (TPV), thermoplastic rubber (TPR), thermoplastic olefin (TPO), thermoplastic polyurethane (TPU), and thermoplastic polyester elastomer (TPEE), are suitable materials for the one-piece molding due to their high plasticity, elasticity, and environmental friendliness.

In one embodiment of the present disclosure, the anti-dropout walls comprise first position-limiting structures; as an example, the anti-dropout walls themselves function as the first position-limiting structures. Each of the male plug and female plug is provided with second position-limiting structures 5. The first position-limiting structures are configured to abut (herein, “abut” means touch, and/or be pressed against) the second position-limiting structures 5 when assembled to prevent the male plug from being disconnected with the female plug or vice versa.

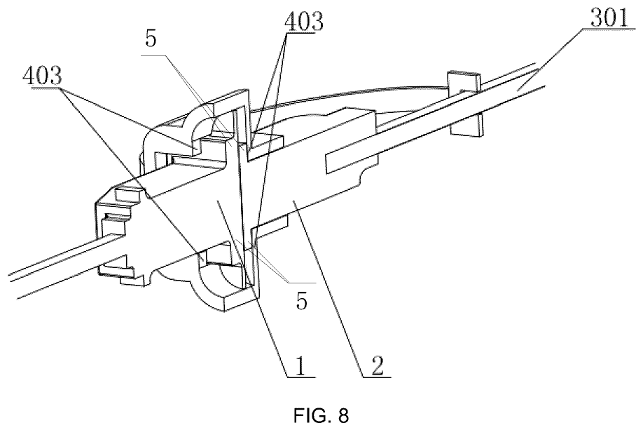

In one embodiment of the present disclosure, as shown in FIG. 8, when assembled, the second position-limiting structures 5 are disposed at outer sides of both the male plug 1 and the female plug 2, and press against the first position-limiting structures, preventing the male plug from being disconnected with the female plug or vice versa.

In one embodiment of the present disclosure, each of the second position-limiting structures of the male plug is disposed at a side surface of the male plug, and the second position-limiting structures of the male plug comprise protrusions from two side surfaces of the male plug (as an example, the protrusions constitute the second position-limiting structures). The second position-limiting structures of the male plug are configured to abut the first position-limiting structures, to prevent the male plug from being disconnected with the female plug or vice versa.

In one embodiment of the present disclosure, each of the second position-limiting structures of the female plug is disposed at a side surface of the female plug and the second position-limiting structures of the female plug comprise protrusions from two side surfaces of the female plug. The second position-limiting structures of the female plug are configured to abut the first position-limiting structures, to prevent the female plug from being disconnected with the male plug or vice versa.

Specifically, the second position-limiting structures of the male plug are disposed at opposite side surfaces of the male plug, respectively, and the protrusions of the male plug extend from these side surfaces; the second position-limiting structures of the female plug are disposed at opposite side surfaces of the female plug, respectively, and the protrusions of the female plug extend from these side surfaces. Each of the second position-limiting structures of the male and female plugs is configured to abut one or more of the first position-limiting structures. When the connected male and female plugs are placed within the through hole through the circumferential gap 402, the two side surfaces of the male plug with the second position-limiting structures and the two side surfaces of the female plug with the second position-limiting structures are matingly connected with the first position-limiting structures inside the through hole, ensuring that the second position-limiting structures of the male and female plugs abut the first position-limiting structures, effectively preventing disconnection due to axial displacement.

In another embodiment of the present disclosure, each of the second position-limiting structures of the male plug is disposed at a side surface of the male plug and the second position-limiting structures of the male plug comprise protrusions from three side surfaces of the male plug. The second position-limiting structures of the male plug are configured to abut the first position-limiting structures, to prevent the male plug from being disconnected with the female plug or vice versa.

Each of the second position-limiting structures of the female plug is disposed at a side surface of the female plug and the second position-limiting structures of the female plug comprise protrusions from three side surfaces of the female plug. The second position-limiting structures of the female plug are configured to abut the first position-limiting structures, to prevent the female plug from being disconnected with the male plug or vice versa.

Specifically, the second position-limiting structures of the male plug are disposed at the three side surfaces of the male plug, respectively, the protrusions of the male plug extend from these side surfaces, and the second position-limiting structures of the male plug abut the first position-limiting structures; the second position-limiting structures of the female plug are disposed at the three side surfaces of the female plug, respectively, the protrusions of the female plug extend from these side surfaces, and the second position-limiting structures of the female plug abut the first position-limiting structures. When the connected male and female plugs are placed within the through hole through the circumferential gap 402, the three side surfaces of the male plug disposed with the second position-limiting structures and the three side surfaces of the female plug disposed with the second position-limiting structures are matingly connected with the first position-limiting structures inside the through hole, ensuring that the second position-limiting structures of the male and female plugs abut the first position-limiting structures, effectively preventing disconnection due to axial displacement.

In yet another embodiment of the present disclosure, each of the second position-limiting structures of the male plug is disposed at a side surface of the male plug and the second position-limiting structures of the male plug comprise protrusions from all side surfaces of the male plug. The second position-limiting structures of the male plug are configured to abut the first position-limiting structures, to prevent the male plug from being disconnected with the female plug or vice versa.

Each of the second position-limiting structures of the female plug is disposed at a side surface of the female plug and the second position-limiting structures of the female plug comprise protrusions from all side surfaces of the female plug. The second position-limiting structures of the female plug are configured to abut the first position-limiting structures, to prevent the female plug from being disconnected with the male plug or vice versa.

Specifically, the second position-limiting structures of the male plug are disposed at the all side surfaces of the male plug, respectively, and the protrusions of the male plug extend from these side surfaces; the second position-limiting structures of the female plug are disposed at the all side surfaces of the female plug, respectively, and the protrusions of the female plug extend from these side surfaces. Each of the second position-limiting structures of the male and female plugs is configured to abut one of the first position-limiting structures. When the connected male and female plugs are placed within the through hole through the circumferential gap 402, each of the second position-limiting structures of the male and female plugs can abut one or more of the first position-limiting structures without considering plug orientation, effectively preventing disconnection due to axial displacement.

When using the anti-dropout structure 4, the active leaf 405 rotates away from the second edge 4022, opening the circumferential gap 402. The male plug 1 and the female plug 2 are first connected to each other and then enter the through hole through the circumferential gap 402. As shown in FIG. 8, the second position-limiting structures 5 of the male and female plugs correspond in terms of number, position, and shape to the first position-limiting structures located at the anti-dropout walls 403 on their respective sides. The second position-limiting structures 5 are configured to abut the first position-limiting structures, effectively preventing disconnection due to axial displacement. After the connected male and female plugs are correctly positioned within the through hole, the active leaf 405 rotates back to the second edge 4022, and the mounting hole 406 of the active leaf 405 snap-fits onto the mounting buckle 404; at which time, the circumferential gap 402 is closed, and the anti-dropout structure 4 secures the connected male and female plugs. To simplify installation, the anti-dropout structure 4 comprises one or more collars 408 and one or more extension lines 407, and the collars 408 are configured to be sleeved around cables 301 of the plugs, such that the anti-dropout structure 4 and the cables 301 form an integrated structure, making installation easier for users, particularly when working at elevated heights.

In one embodiment of the present disclosure, the male plug comprises two second position-limiting structures, which are disposed at opposite side surfaces of the male plug; the female plug has a similar configuration to that of the male plug. In another embodiment of the present disclosure, the male plug comprises three second position-limiting structures, which are disposed at three side surfaces of the male plug; the female plug has a similar configuration to that of the male plug. In yet another embodiment of the present disclosure, the second position-limiting structures of the male plug are annularly disposed at all side surfaces of the male plug; the female plug has a similar configuration to that of the male plug. It should be noted that the specific embodiments described herein are only illustrative, and are not intended to restrict the present disclosure.

In one embodiment of the present disclosure, the second position-limiting structures of the male plug are disposed at a top portion, a middle portion and/or a bottom portion of the male plug; the second position-limiting structures of the female plug are disposed at a top portion, a middle portion and/or a bottom portion of the female plug.

In one embodiment of the present disclosure, each of the second position-limiting structures of the male plug extends outward from a corresponding side surface of the male plug at an angle with said side surface; each of the second position-limiting structures of the female plug extends outward from a corresponding side surface of the female plug at an angle with said side surface.

In a preferred embodiment of the present disclosure, each second position-limiting structure of the male and female plugs extends outwards from a corresponding side surface in a direction perpendicular to said side surface.

In one embodiment of the present disclosure, each of the second position-limiting structures of the male plug and the female plug matches one of the first position-limiting structures. The anti-dropout structure comprises at least two first position-limiting structures.

Specifically, the first position-limiting structures correspond in terms of number, position, and shape to the second position-limiting structures 5. The number and structure of the anti-dropout walls 403 corresponding to the first position-limiting structures vary based on those of the second position-limiting structures 5 of the male and female plugs. Generally, the anti-dropout structure comprises at least two anti-dropout walls 403.

Further, the male plug and the second position-limiting structures disposed thereon are formed by one-piece molding of PVC plastic materials, and the female plug and the second position-limiting structures disposed thereon are formed by one-piece molding of PVC plastic materials.

In summary, the anti-dropout structure and the plug of the present disclosure have the following advantages.

By incorporating the anti-dropout structure at the cables of the male and female plugs, it effectively prevents loosening due to pulling force, enhancing product safety and user experience. Moreover, the anti-dropout structure can be directly applied to existing plugs, making it simple to use and widely applicable.

The anti-dropout structure features a straightforward design and can be achieved through one-piece molding, reducing production costs and improving efficiency.

This anti-dropout structure is designed to integrate the cables of the male and female plugs through the collars and extension lines, making installation easier for users, particularly when working at elevated heights.

The second position-limiting structures of the male and female plugs are configured to abut the first position-limiting structures on the anti-dropout structure, effectively preventing axial displacement and ensuring reliable connections.

The above-mentioned embodiments are merely illustrative of the principle of the present disclosure instead of limiting the present disclosure. Any non-substantive modifications made to the present disclosure within the principles of the present disclosure should be included in the protection scope of the present disclosure.

1. An anti-dropout structure for plugs, wherein the anti-dropout structure comprises a ring sleeve, the ring sleeve has an axial through hole, and the through hole of the ring sleeve is configured for accommodating a male plug and a female plug; wherein the ring sleeve is provided with a circumferential gap including an opening and closing structure; wherein the male plug and female plug are configured to enter the through hole through the circumferential gap, and the ring sleeve further comprises anti-dropout walls protruding toward the through hole for preventing the male plug and the female plug from dropping out of the anti-dropout structure; wherein the anti-dropout walls comprise first position-limiting structures, and each of the male plug and female plug is provided with second position-limiting structures; wherein the first position-limiting structures are configured to abut the second position-limiting structures to prevent the male plug and the female plug from dropping out of the anti-dropout structure.

2. The anti-dropout structure according to claim 1, wherein the opening and closing structure comprises a mounting buckle and an active leaf, the ring sleeve comprises a first edge and a second edge, and the first edge is spaced apart from the second edge to form the gap; wherein one side of the active leaf is connected to the first edge, and the active leaf is rotatable around the first edge; wherein the mounting buckle is disposed on the second edge, and the active leaf is provided with a mounting hole snap-fittedly connected to the mounting buckle.

3. The anti-dropout structure according to claim 1, wherein the anti-dropout structure comprises one or more extension lines and one or more collars, wherein a first end of each extension line is connected to the ring sleeve, a second end of each extension line is connected to one of the collars, and the collars are configured to be sleeved around cables of the plugs.

4. The anti-dropout structure according to claim 3, wherein the extension lines comprise a first extension line and a second extension line, and the collars comprise a first collar and a second collar; wherein a first end of the first extension line is connected to the ring sleeve, a second end of the first extension line is connected to the first collar, and the first collar is configured to sleeve around the cable of one of the male plug and the female plug; wherein a first end of the second extension line is connected to the ring sleeve, a second end of the second extension line is connected to the second collar, and the second collar is configured to sleeve around the cable of the other one of the male plug and the female plug.

5. The anti-dropout structure according to claim 1, wherein the ring sleeve is formed by one-piece molding using soft materials.

6. The anti-dropout structure according to claim 1, wherein each of the second position-limiting structures of the male plug is disposed at a side surface of the male plug and the second position-limiting structures of the male plug comprise protrusions from two side surfaces of the male plug; wherein the second position-limiting structures of the male plug are configured to abut the first position-limiting structures, to prevent the male plug from being disconnected with the female plug.

7. The anti-dropout structure according to claim 6, wherein each of the second position-limiting structures of the female plug is disposed at a side surface of the female plug and the second position-limiting structures of the female plug comprise protrusions from two side surfaces of the female plug; wherein the second position-limiting structures of the female plug are configured to abut the first position-limiting structures, to prevent the female plug from being disconnected with the male plug.

8. The anti-dropout structure according to claim 1, wherein each of the second position-limiting structures of the male plug is disposed at a side surface of the male plug and the second position-limiting structures of the male plug comprise protrusions from three side surfaces of the male plug; wherein the second position-limiting structures of the male plug are configured to abut the first position-limiting structures, to prevent the male plug from being disconnected with the female plug.

9. The anti-dropout structure according to claim 8, wherein each of the second position-limiting structures of the female plug is disposed at a side surface of the female plug and the second position-limiting structures of the female plug comprise protrusions from three side surfaces of the female plug; wherein the second position-limiting structures of the female plug are configured to abut the first position-limiting structures, to prevent the female plug from being disconnected with the male plug.

10. The anti-dropout structure according to claim 1, wherein each of the second position-limiting structures of the male plug is disposed at a side surface of the male plug and the second position-limiting structures of the male plug comprise protrusions from all side surfaces of the male plug; wherein the second position-limiting structures of the male plug are configured to abut the first position-limiting structures, to prevent the male plug from being disconnected with the female plug.

11. The anti-dropout structure according to claim 10, wherein each of the second position-limiting structures of the female plug is disposed at a side surface of the female plug and the second position-limiting structures of the female plug comprise protrusions from all side surfaces of the female plug; wherein the second position-limiting structures of the female plug are configured to abut the first position-limiting structures, to prevent the female plug from being disconnected with the male plug.

12. The anti-dropout structure according to claim 1, wherein the second position-limiting structures of the male plug are disposed at a top portion, a middle portion, and/or a bottom portion of the male plug; wherein the second position-limiting structures of the female plug are disposed at a top portion, a middle portion and/or a bottom portion of the female plug.

13. The anti-dropout structure according to claim 1, wherein each of the second position-limiting structures of the male plug extends outward from a corresponding side surface of the male plug at an angle with said side surface, and each of the second position-limiting structures of the female plug extends outward from a corresponding side surface of the female plug at an angle with said side surface.

14. The anti-dropout structure according to claim 1, wherein each of the second position-limiting structures of the male plug and the female plug matches one of the first position-limiting structures; wherein the anti-dropout structure comprises at least two first position-limiting structures.

15. The anti-dropout structure according to claim 1, wherein the male plug and the second position-limiting structures disposed thereon are formed by one-piece molding of PVC plastic materials, and the female plug and the second position-limiting structures disposed thereon are formed by one-piece molding of PVC plastic materials.

16. A plug comprising the anti-dropout structure according to claim 1.
